(19) United States
(12) Patent Application Publication
(10) Pub. No.: US 2007/0286477 A1
(43) Pub. Date: Dec. 13, 2007

(54) Method and system for fast and accurate face detection and face detection training

(75) Inventors: Jung Bae Kim, Yongin-si (KR); Haibing Ren, Beijing (CN); Ji Yeun Kim, Seoul (KR); Haitao Wang, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/652,070

(22) Filed: Jan. 11, 2007

(30) Foreign Application Priority Data
Jun. 9, 2006 (KR) 10-2006-0052152

(51) Int. Cl. G06K 9/62

(52) U.S. Cl. 382/159; 382/224

(57) ABSTRACT

A face detection method where a cascaded weak classifier and a result of a previous stage are combined. The weak classifier is based on a modified double sigmoid function to precisely and effectively estimate each Haar feature. The face detection method includes a method of training a parameter of a new weak classifier.

### CROSS-REFERENCE TO RELATED APPLICATION

This application claims the benefit of Korean Patent Application No. 10-2006-0052152, filed on Jun. 9, 2006, in the Korean Intellectual Property Office, the disclosure of which is incorporated herein by reference.

### BACKGROUND OF THE INVENTION

1. Field

Methods and systems consistent with the present invention relate to face detection, and more particularly, to face detection which accurately and effectively estimates a Haar feature which is used in a weak classifier by using a modified double sigmoid function, combines a cascaded and a weighed chain so that a result of a previous stage is reflected in a result of a current stage, and notably reduce a number of a weak classifier associated with a stage, as well as computation time.

2. Related Art

A human being is an essential piece of information in digital content management, face detection, three-dimensional (3D) face modeling, animation, an avatar, smart surveillance, and digital entertainment.

Accordingly, processing is performed in the areas for finding the human being in images/videos. One way of processing is to detect a face, which is an obvious and stable feature of a human being, in images/videos.

When a face of a human being is not correctly detected in images/videos, face feature detection, tracking, human segmentation, face recognition, and smart surveillance may not be reliable.

Hereinafter, a related art example of embodying an avatar, based on a face detected in images, will be described.

According to the related art, a face detection method identifies eyes, a nose, a mouth, and the like, in a human face in still images which have been transmitted to a terminal, and considers locations and spaced distances of the identified eyes, nose, mouth, and the like. Accordingly, the avatar most similar to the human face may be embodied. Specifically, the face detection method according to the related art identifies points of the still images corresponding to the eyes, the nose, the mouth, and the like, of the human being. Also, the face detection method according to the related art creates the avatar with images of the eyes, nose, mouth, and the like, corresponding to the identified point.

When the eyes, nose, mouth, and the like, are not detected in still images in the related art, an avatar may not be properly embodied.

For a substantially fast and accurate face detection, the face detection method according to the related art divides images/videos into a plurality of sub-windows, and determines whether a human face is included in each of the sub-windows.

FIG. 1 is a diagram illustrating an example of a face detection method according to the related art. FIG. 1 illustrates a process which divides still images into a plurality of sub-windows, and determines whether each sub-window is a face candidate.

The face detection method in FIG. 1 divides original input images into an n number of sub-windows, confirms whether a human face is included in the divided sub-windows, and merges every sub-window including the human face. Accordingly, the face detection method in FIG. 1 may precisely find a position and size of the human face.

As an example, the face detection method in FIG. 1 may divide a 320*240 input image into at least 500,000 sub-windows in consideration of different divisional boundaries and scale. For face candidate verification with respect to a number of sub-windows, a fast and accurate face detection verification with respect to each of the sub-windows is required.

Reference information of the related art includes:

1) U.S. Pat. No. 7,020,337, Mar. 28, 2006, Viola et al., entitle “System and method for detecting objects in images”,

2) U.S. Pat. No. 6,661,907, Dec. 9, 2003, Ho et al., entitled “Face detection in digital images”, and

3) U.S. Pat. No. 5,642,431, Jun. 24, 1997, Poggio et al., “Network-based system and method for detection of faces and the like”.

In the foregoing related art reference (3), a neural network is used as the face candidate verifier. However, these related art methods could not be used in a real world application due to computation and accuracy problems.

In the foregoing related art reference (2), skin color is used to decrease computation time. However, a surrounding environment, illumination, occlusion, and the skin color itself can easily interfere with this method.

In the foregoing related art reference (1), cascaded face candidate verifiers are presented. A Haar feature is quickly calculated by the cascaded face candidate verifiers, and their performances are better than the verifiers of references 2 and 3 described above.

However, a related art image detection system based on the face candidate verifier may still have a problem and/or disadvantage. The face candidate verifier in these types of systems includes two main parts. One is a cascaded structure, and the other is a weak classifier.

FIG. 2 is a diagram illustrating an example of a cascaded face candidate verifier structure according to the related art. According to the related art, each stage has a strong classifier to identify a non-face area. The strong classifiers are independent from each other with respect to each of the stages. Specifically, according to the related art, a confidence extracted from a previous stage is available only with respect to the previous stage. Also, the confidence is not used in a current stage, and will not be used in subsequent stages.

In actual use, most face areas have a higher confidence, and most non-face areas have a lower confidence. Accordingly, the confidence of the previous stage is a good weak classifier. However, in the related art, calculations used for acquiring the confidence of the previous stage are wasted.

FIG. 3 is a diagram illustrating an example of a binary weak classifier and a discrete strong classifier according to the related art. Each stage has a strong classifier Hₙ(x) to reject a non-face area. The strong classifier Hₙ(x) includes a plurality of weak classifiers as shown below,

Hₙ(x)=βₙ₋₁Hₙ₋₁(x)+Σαᵢhᵢ(x)

Here, h is an i^{th} weak classifier. According to the foregoing cited related art, the weak classifier obtains a Haar feature value g with respect to a sub-window x, and inputs the Haar feature value g in a binary function f as shown in part i) of FIG. 3. A single weak classifier is composed of a single Haar feature and a single binary function.

Also, t is a threshold. When g is greater than t, a result is a. Otherwise, the result is b. Accordingly, as shown in part ii) of FIG. 3, the strong classifier Hₙ(x) according to the conventional art is a discrete function with 2ⁿ levels. The strong classifier including an n number of weak classifiers has no more than a number of discrete values. In this instance, when n is small, a positive sample and a negative sample may not be correctly classified.

According to the related art, more weak classifiers are used to achieve good classification performance. However, computation time is increased due to computing increased numbers of weak classifiers.

Accordingly, setting an appropriate number of the weak classifiers for each stage is crucial when considering the computation time. Specifically, the number of the weak classifier of first several stages greatly affects the computation time. Accordingly, maintaining fewer weak classifiers in the first several stages is critical.

FIG. 4 is a diagram illustrating a histogram with respect to a Haar feature value. As shown in FIG. 4, the histogram of the Haar feature value g includes distributions of a positive sample and a negative sample. A high value indicates a high confidence of the positive sample, and a low value indicates a high confidence of the negative sample. Specifically, the larger the difference between a maximum exterior angle and the threshold, the higher the confidence of the samples. The foregoing description is helpful for classification of the samples. However, in the related art, the information was not used in the binary weak classifier due to poor classification ability. A strong classifier for achieving a particular level of performance requires additional weak classifiers.

According to a computation complexity equation below, the computation time of a face candidate verifier is completely determined by the number of the weak classifier.

O(l₁+l₂*θ¹+ . . . +lₙ*θⁿ⁻¹)

Here, the 1 is a number of the weak classifier of an i^{th} stage. Also, the θ is a false positive rate of each stage. According to the computation complexity equation, the fewer the number of weak classifiers, the faster the face detection time.

Thus, a face detection model, which sets the fewest and the most optimal number of weak classifiers for each stage to improve accuracy of a face detection and reduce a detection time, is a need that is not met by the related art.

### SUMMARY OF THE INVENTION

The invention provides a face detection method and system, including a weak classifier by using a modified double sigmoid function, and thereby may estimate a Haar feature with accuracy and use fewer weak classifiers for each stage.

The present invention also provides a face detection method and system, including a combination of a cascaded and a weighted chain, and thereby may use a confidence of a previous stage.

The present invention also provides a face detection training method and system, including a method of training weight of a strong classifier, and thereby may obtain an optimal weight and parameter in each weak classifier.

According to an aspect of the present invention, there is provided a face detection method including: calculating a weak classifier associated with a stage, from a modified double sigmoid function; and estimating a Haar feature by using the calculated weak classifier.

According to another aspect of the present invention, there is provided a face detection method where a cascaded weak classifier and a result of a previous stage are combined. The weak classifier is based on a modified double sigmoid function in order to estimate each Haar feature.

### BRIEF DESCRIPTION OF THE DRAWINGS

The above and/or other aspects of the present invention will become apparent and more readily appreciated from the following detailed description of exemplary embodiments, taken in conjunction with the accompanying drawings of which:

FIG. 1 is a diagram illustrating an example of a face detection method according to the related art;

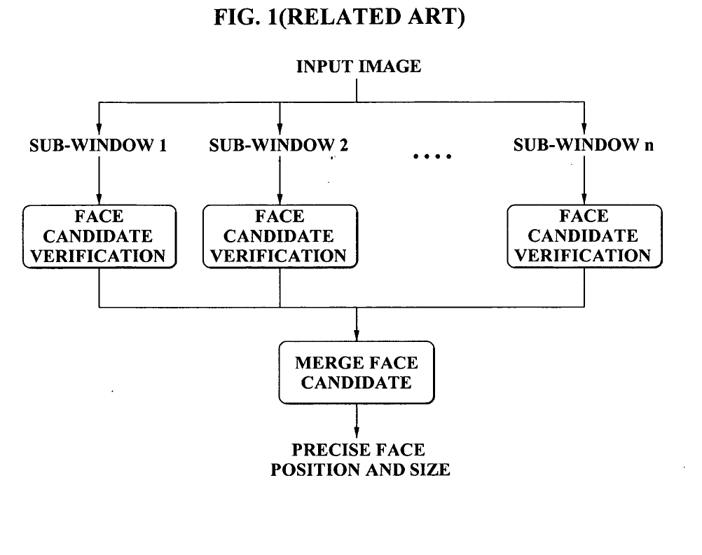

FIG. 2 is a diagram illustrating an example of a cascaded face candidate verifier structure according to the related art;

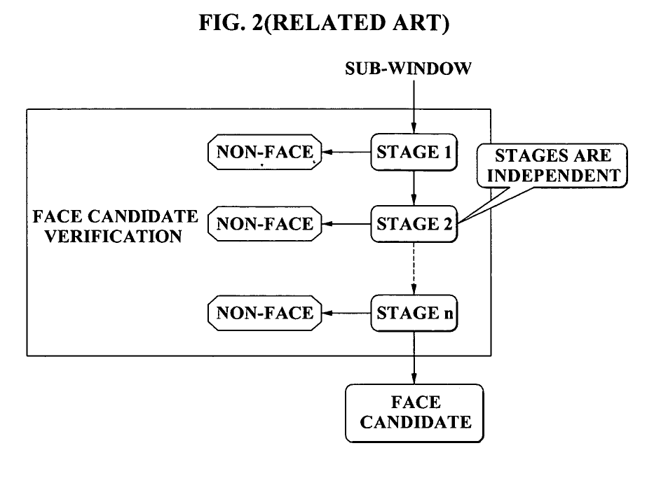

FIG. 3 is a diagram illustrating an example of a binary weak classifier and a discrete strong classifier according to the related art;

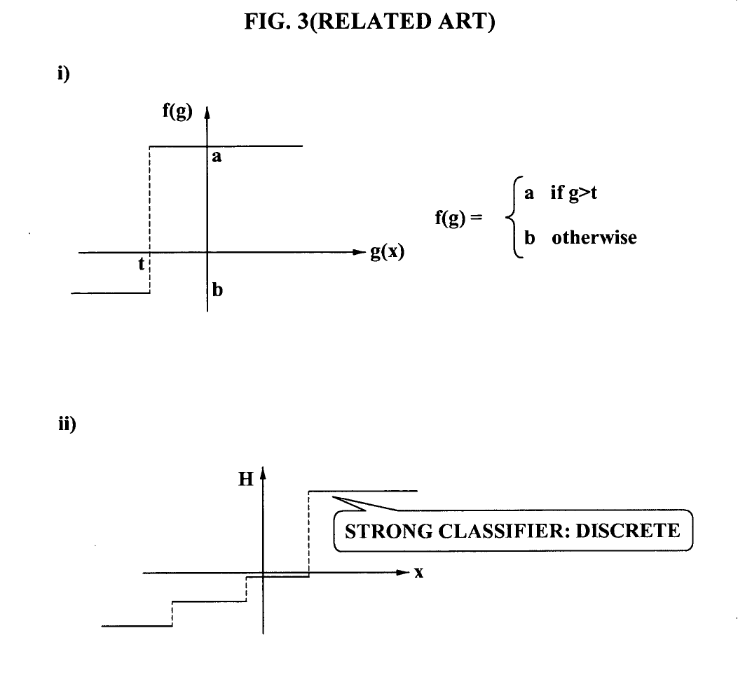

FIG. 4 is a diagram illustrating a histogram with respect to a Haar feature value;

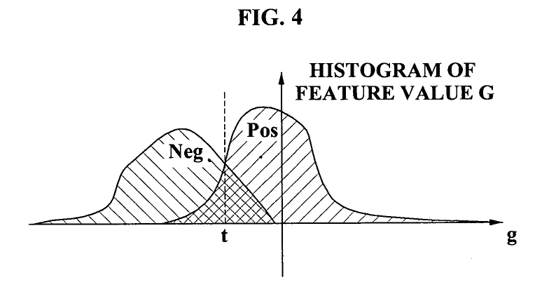

FIG. 5 is a diagram illustrating a structure of a fast and accurate face detection system according to an exemplary embodiment of the present invention;

FIG. 6 is a diagram illustrating a double sigmoid function according to an exemplary embodiment of the present invention;

FIG. 7 is a diagram illustrating a parameter of a modified double sigmoid weak classifier according to an exemplary embodiment of the present invention;

FIG. 8 is a diagram illustrating a combination structure of a face candidate verifier according to an exemplary embodiment of the present invention;

FIG. 9 is a flowchart illustrating operations of training a face detection system according to another exemplary embodiment of the present invention; and

FIG. 10 is a diagram illustrating a size of coefficient c which varies according to a stage.

### DETAILED DESCRIPTION OF EXEMPLARY EMBODIMENTS

Reference will now be made in detail to exemplary, non-limiting embodiments of the present invention, examples of which are illustrated in the accompanying drawings, wherein like reference numerals refer to the like elements throughout. The embodiments are described below in order to provide a description with respect to the figures.

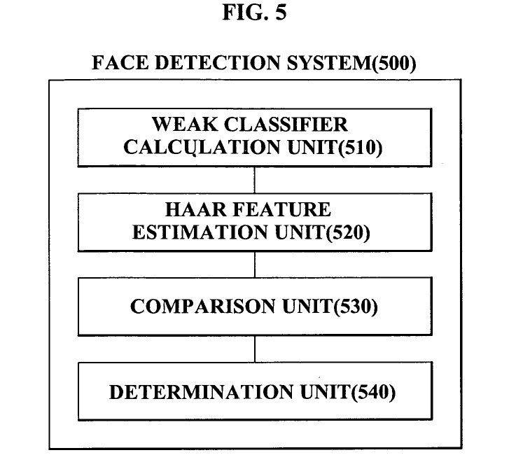

FIG. 5 is a diagram illustrating a structure of a fast and accurate face detection system according to an exemplary embodiment.

A face detection system 500 includes a weak classifier calculation unit 510 calculating a weak classifier associated with a stage, from a modified double sigmoid function. Specifically, the weak classifier calculation unit 510 modifies a typical double sigmoid function, and provides the modified double sigmoid function. Also, the weak classifier calculation unit 510 uses the induced modified double sigmoid function, and calculates the weak classifier. The weak classifier may effectively estimate a Haar feature with respect to a sub-window.

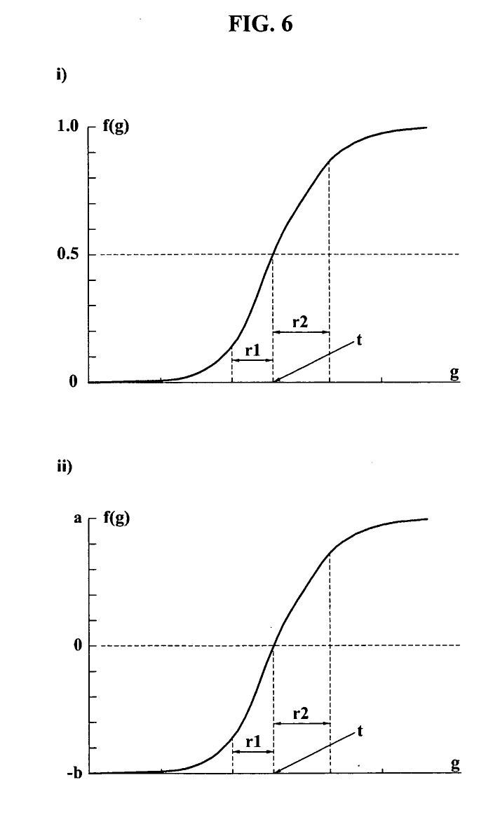

FIG. 6 is a diagram illustrating a double sigmoid function according to an exemplary embodiment of the present invention. Part i) of FIG. 6 illustrates a typical double sigmoid function. Part ii) of FIG. 6 illustrates the modified double sigmoid function.

The typical double sigmoid function of FIG. 6 (i) determines a range of a weak classifier f(g) with respect to a Haar feature value g as a continuous value from 0 to 1. In this instance, the Haar feature value g is in an unbounded range. In this instance, a configuration of the double sigmoid function to be applied may vary according to whether the Haar feature value g is greater than a set threshold t.

Part i) of FIG. 6 illustrates that, when the Haar feature value g is less than the set threshold, a value of the weak classifier f(g) is calculated to be less than a value, for example, 0.5. In this instance, the value of the weak classifier f(g) is calculated by the double sigmoid function.

The typical double sigmoid function may be represented as a function in which the Haar feature value g is a parameter, as shown in equation 1.

$$f ( g ) = \{ \begin{matrix}\frac{1}{1 + exp ( - 2 \frac{g - t}{r 1} )} & if g < t \\ \frac{1}{1 + exp ( - 2 \frac{g - t}{r 2} )} & o . w .\end{matrix} \qquad [ Equation 1 ]$$

Here, the t is a threshold of two sigmoids, the r₁ determines a variation of a first sigmoid, and the r₂ determines a variation of a second sigmoid.

In part ii) of FIG. 6, a modification of the function is performed so that the typical double sigmoid function f(g) varies with a feature histogram. Specifically, the modified double sigmoid function of part ii) of FIG. 6 may determine a range of a weak classifier f(g) with respect to a Haar feature value g as a continuous value from −b to a. In this instance, the Haar feature value g is in unbounded range.

The modified double sigmoid function may be represented as a function in which the Haar feature value g is an input parameter, as shown in equation 2.

Equation 2

$$f ( g ) = [ \begin{matrix}b \frac{1 - exp ( - 2 \frac{g - t}{{r}_{1}} )}{1 + exp ( - 2 \frac{g - t}{{r}_{1}} )} & if g < t \\ a \frac{1 - exp ( - 2 \frac{g - t}{{r}_{2}} )}{1 + exp ( - 2 \frac{g - t}{{r}_{2}} )} & Otherwise\end{matrix}$$

Here, b is a weight of a first sigmoid, and a is a weight of a second sigmoid.

Specifically, a weak classifier calculation unit 510 of the face detection system 500 may calculate the weak classifier f(g) by using the modified double sigmoid function.

The modified double sigmoid function f(g) of equation 2 has the following features:
1) The modified double sigmoid function is a continuous function, not a discrete function.
2) The modified double sigmoid function significantly varies near the threshold, and varies substantially less far from the threshold.
3) The modified double sigmoid function changes a variation of confidence according to a distribution of a positive sample and a negative sample.
4) The modified double sigmoid function has limits on the two ends.
5) The modified double sigmoid function may use a lookup table for fast computation.

In an exemplary embodiment, only the five parameters, t, r₁, r₂, b, and a, need to be estimated with respect to calculation of each of the weak classifier f(g).

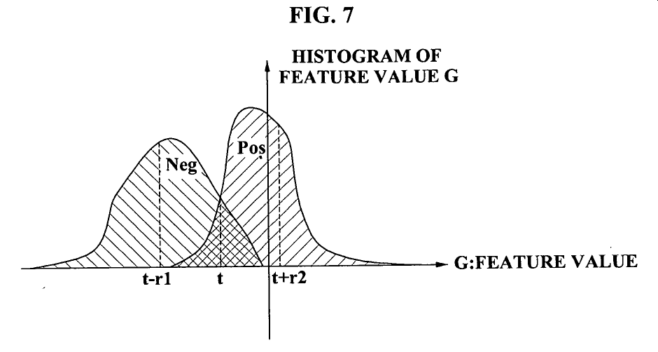

FIG. 7 is a diagram illustrating a parameter of a modified double sigmoid weak classifier according to an exemplary embodiment.

As described above, a weak classifier of a stage is calculated by a modified double sigmoid function. Also, t, r₁, r₂, b, and a described above are used as a parameter in the modified double sigmoid function. The parameter may be estimated by distributions of a negative sample and a positive sample of the modified double sigmoid function.

FIG. 7 illustrates a feature distribution in which a first sigmoid having a variation r₁ and a second sigmoid having a variation r₂ are overlapped at the location of a threshold t.

The parameter t indicates a threshold which can most suitably distinguish between the negative sample and the positive sample in the feature distribution as shown in FIG. 7. The parameter t may be a set value. In this instance, the set value ensures a sum of a negative sample range and a positive sample range is a minimum. In this instance, the negative sample range is greater than the set value, and the positive sample range is less than the set value.

Specifically, the parameter t is determined by,

$$t = \text{arg} min ( {\sum }_{{X}_{i} ∈ {S}_{N} \& {g}_{i} > t} {W}_{i} {g}_{i} + {\sum }_{{X}_{i} ∈ {S}_{P} \& {g}_{i} < t} {W}_{i} {g}_{i} ) \qquad [ Equation 3 ]$$

Here, Sₚ is a set of positive training samples, and Sₙ is a set of negative training samples. Also, gᵢ is a feature value of an i^{th} sample xᵢ with respect to a feature g, and the wᵢ is a histogram value of the feature value gᵢ.

An antecedent of equation 3 may indicate an integral value of the negative sample range which overlaps the positive sample range. In this instance, the negative sample range which overlaps the positive sample range is included in the negative sample range, and a range in which the feature g is greater than the set value t.

A result of equation 3 may indicate an integral value of the positive sample range which overlaps the negative sample range. In this instance, the positive sample range which overlaps the negative sample range is included in the positive sample range, and a range in which the feature g is less than the set value t.

Specifically, equation 3 determines the predetermined set value t as an optimal parameter t of the threshold. In this instance, the set value t is under a condition that a range where the negative sample range and the positive sample range are overlapped is a minimum.

Parameter r₁ determines a set value r₁. In this instance, the set value r₁ calculates a constant value, when dividing the negative sample range, which is less than the predetermined set value r₁ based on a parameter t, into a sample set S_{N}.

Also, a parameter r₂ determines a set value r₂. In this instance, the set value r₂ calculates a constant value, when dividing the positive sample range, which is greater than the set value r₂ based on the parameter t, into a sample set S_{P}.

In this instance, the constant values associated with the parameter r₁ and the parameter r₂ are identical.

Specifically, the parameter r₁ and the parameter r₂ is determined by,

$$\frac{{\sum }_{{X}_{i} ∈ {S}_{N} \& {g}_{i} < t - {r}_{1}} {W}_{i} {g}_{i}}{\vert {S}_{N} \vert} = \frac{{\sum }_{{X}_{i} ∈ {S}_{P} \& {g}_{i} > t + {r}_{2}} {W}_{i} {g}_{i}}{\vert {S}_{P} \vert} = CONST \qquad [ Equation 4 ]$$

Parameter a is determined by dividing the integral value of the positive sample range into a sum of the integral value of the positive sample range and the integral value of the negative sample range. In this instance, the integral value of the negative sample range and the integral value of the positive sample range are greater than the parameter t.

Specifically, the parameter a is determined by,

Equation 5

$$a = \frac{{\sum }_{{X}_{i} ∈ {S}_{P} \& {g}_{i} > t} {W}_{i} {g}_{i}}{{\sum }_{{X}_{i} ∈ {S}_{N} \& {g}_{i} > 1} {W}_{i} {g}_{i} + {\sum }_{{X}_{i} ∈ {S}_{P} \& {g}_{i} > t} {W}_{i} {g}_{i}}$$

Here, the integral value,

$${\sum }_{{X}_{i} ∈ {S}_{N} \& {g}_{i} > t} {W}_{i} {g}_{i} ,$$

of the negative sample range which is greater than the parameter t indicates an error.

Parameter b is determined by dividing the integral value of the negative sample range into a sum of the integral value of the negative sample range and the integral value of the positive sample range. In this instance, the integral value of the negative sample range and the integral value of the positive sample range are less than the parameter t, respectively.

Specifically, the parameter b is determined by,

$$b = \frac{{\sum }_{{X}_{i} ∈ {S}_{N} \& {g}_{i} < t} {W}_{i} {g}_{i}}{{\sum }_{{X}_{i} ∈ {S}_{N} \& {g}_{i} < t} {W}_{i} {g}_{i} + {\sum }_{{X}_{i} ∈ {S}_{P} \& {g}_{i} < t} {W}_{i} {g}_{i}} \qquad [ Equation 6 ]$$

Here, the integral value of the positive sample range,

$${\sum }_{{X}_{i} ∈ {S}_{P} \& {g}_{i} < t} {W}_{i} {g}_{i} ,$$

which is less than the parameter t indicates an error.

Accordingly, the face detection system 500 according to an exemplary embodiment may determine five parameters associated with a calculation of the modified double sigmoid weak classifier.

Referring again to FIG. 5, the face detection system 500 includes a Haar feature estimation unit 520 estimating a Haar feature by using the calculated weak classifier. Specifically, the Haar feature estimation unit 520 compares a calculated value of the modified double sigmoid function with a reference value. According to a result of the comparison, samples associated with the weak classifier may be distinguished as the negative sample or the positive sample.

As an example, when the reference value is set as 0, the face detection system 500 compares the calculated value and 0. According to the result of the comparison, the calculated value, a weak classifier f(g), is less than 0, which is negative, the face detection system 500 determines the sample of the associated weak classifier as a negative sample. Also, when the weak classifier f(g) is greater than 0, which is positive, the face detection system 500 distinguishes the sample of the associated weak classifier as a positive sample.

Also, the face detection system 500 includes a comparison unit 530 comparing a calculated value of a strong classifier Hₙ(x), based on an estimation of the Haar function, with a reference value. Specifically, the comparison unit 530 calculates a calculated value of the strong classifier Hₙ(x) which is a weighted sum of the weak classifier with respect to a particular stage. Then, the comparison unit 530 compares the calculated value of the strong classifier Hₙ(x) with a reference value which has been set by an operator, for example, an operator of the system.

Also, the face detection system 500 includes a determination unit 540 determining a sub-window of an input image associated with the stage as a face or a non-face, based on the result of the comparison by the comparison unit 530. Specifically, when the calculated strong classifier Hₙ(x) is greater than the reference value, the determination unit 540 determines and confirms the non-face with respect to the sub-window in a current stage.

When the calculated strong classifier Hₙ(x) does not satisfy the reference value, the face detection system 500 calculates a weighted sum associated with a subsequent weak classifier, and compares the reference value with the strong classifier Hₙ(x) including the weighted sum. Otherwise, the face detection system 500 moves to a subsequent stage and determines the sub-window as a face or a non-face again.

Accordingly, the face detection system 500 proposes a weak classifier by using the modified double sigmoid function. Accordingly, the face detection system 500 may estimate the Haar feature with a high accuracy and use less weak classifiers for each stage.

The face detection system 500 combines a cascaded and a result of a previous stage. Accordingly, the face detection system 500 may improve an accuracy of face detection, and reduce computation time.

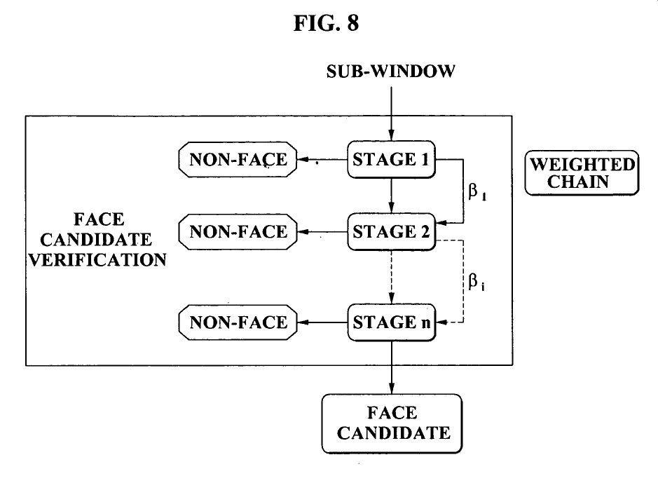

FIG. 8 is a diagram illustrating a combination structure of a face candidate verifier according to an exemplary embodiment of the present invention. The face detection system 500 uses a confidence of a previous stage, an n-1^{st} stage, when extracting a confidence of a current stage. Accordingly, the face detection system 500 may reduce a number of weak classifiers to be calculated, and also computation time.

Specifically, according to the related art, the face detection method independently estimates a sub-window for each stage regardless of relationship of stages. However, the face detection system 500 uses the confidence of the previous stage in the current stage. Particularly, the face detection system 500 uses the confidence of the previous stage as a first weak classifier of the current stage, and a performance of the previous stage as a weight.

A strong classifier Hₙ(x) is determined by,

Hₙ(x)=βₙ₋₁Hₙ₋₁(x)+Σαᵢhᵢ(x) [Equation 7]

The Hₙ₋₁(x) is a strong classifier of an n-1^{th} stage and the βₙ₋₁ indicates a weight of the Hₙ₋₁(x). Also, equation 7 is a combination of a cascaded and a weighed chain. Through equation 7, the sub-window is estimated.

As shown in equation 7, the confidence of the previous stage, Hₙ₋₁(x), is used as a first weak classifier of the current stage. Accordingly, a confidence which has been extracted from a first stage has the greatest affect on an estimation of all sub-windows.

Accordingly, the face detection system 500 may require more precise confidence extraction with respect to the first stage or first several stages, when determining a particular sub-window.

Hereinafter, according to another exemplary embodiment, a method and system for training the face detection system 500 will be described.

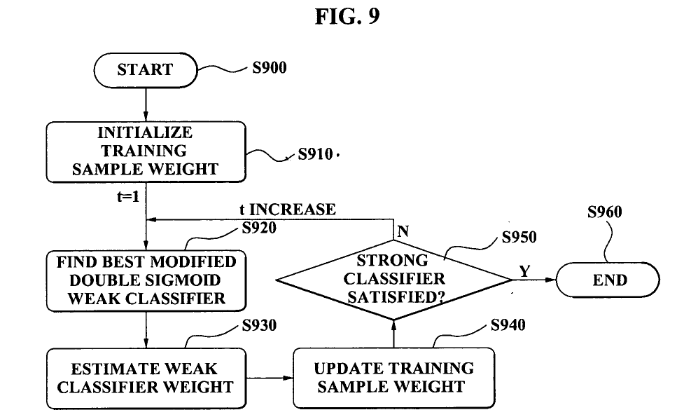

FIG. 9 is a flowchart illustrating operations of training a face detection system according to another exemplary embodiment. The face detection system 500 prepares a number of stages for estimating a particular sub-window, and estimates a non-face determination or a non-face determination deferral with respect to the sub-window for each stage.

Specifically, when a calculated value of a strong classifier satisfies a value in a particular stage, the face detection system 500 determines and confirms the associated sub-window as a non-face.

Also, when the calculated value of the strong classifier does not satisfy the value in the particular stage, the face detection system 500 calculates a subsequent weak classifier, and determines the non-face determination or the non-face determination deferral in a current stage again. Otherwise, the face detection system 500 continues to a subsequent stage, and repeatedly estimates the sub-window.

When the non-face is not determined in the prepared stages, the face detection system 500 may determine the associated sub-window as the face, and recognizes that the sub-window is associated with a human face.

The face detection system 500 may determine weak classifiers of each of the stages and each of the weights through training by a face detection training method or a face detection training system.

In FIG. 9, the face detection training method is illustrated. In this instance, the face detection training method determines a weak classifier and weight of a stage by using a training sample, and creates a strong classifier. The face detection training method according to another exemplary embodiment may be performed by the face detection training system.

In operation S910 after start S900, the face detection training system initializes a training sample weight. In this instance, a value of the training sample weight is set as a size. Also, the training sample weight in each stage is controlled by using a coefficient c. A positive sample weight may be defined as (c−1)/(2*Np*(c+1)). Also, a negative sample weight may be defined as 1/(Nn*(c+1)). In this instance, the Np indicates a positive sample number, and the Nn indicates a negative sample number.

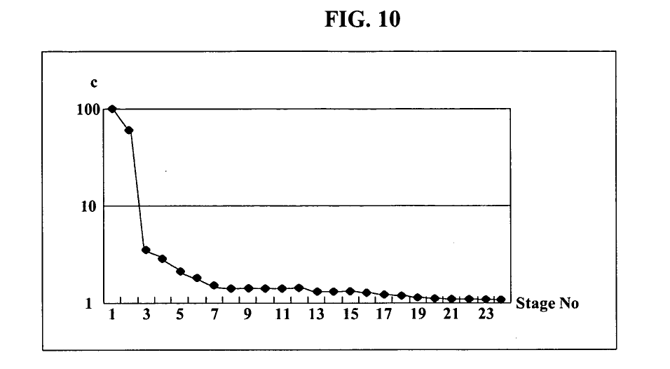

FIG. 10 is a diagram illustrating a size of coefficient c which may vary according to a stage. Also, the coefficient c is large in the initial several stages, and the coefficient c is notably decreased in later stages. For example, the coefficient c of a first stage is 100, whereas the coefficient c of a twentieth stage may be approximately 1. Accordingly, the positive sample is considered more important than the negative sample, in the initial several stages in which the coefficient c is large.

In operation S920, the face detection training system selects the best modified double sigmoid weak classifier. In this instance, an i^{th} weak classifier of an n^{th} stage is sequentially found. As an example, the face detection training system may calculate a first weak classifier h₁ of the first stage by the modified double sigmoid function. In this instance, parameters t, a, b, r₁, and r₂, which are used in the modified double sigmoid function, may be determined by using equations 3, 4, 5, and 6, respectively. In this instance, a condition that the training sample weight w is set as an initial value is required.

In operation S930, the face detection training system estimates a weight of the weak classifier from the calculated weak classifier h₁. In this instance, an i^{th} weight which is multiplied by the i^{th} weak classifier is calculated. Accordingly, the face detection training system allows the i^{th} weight of the strong classifier to be calculated.

When estimating a weight of the weak classifier, the face detection training system uses a cost function, and calculates a weight α in which a calculated value of the cost function is a minimum.

The cost function may be determined by,

$${Z}_{t} = \sum {w}_{t} ( i ) \cdot exp ( - {α}_{t} {y}_{i} {h}_{t} ( {x}_{i} ) ) \cdot exp ( {λα}_{t} {y}_{i} ) \\ λ = \frac{c - 1}{c + 1} \qquad [ Equation 8 ]$$

Here, a training sample is defined as a combination of an input area and a class index, and indicated as (x₁, y₁), (x₂, y₂) . . . , and (xₘ, yₘ). The wₜ(i) is a training sample weight, and the αₜ is a weak classifier weight. The wᵢ(i) indicates an initial value.

When calculating the weight α of the first weak classifier h₁, the face detection training system may calculate a weight α₁ by using the minimum value of the cost function. In this instance, the minimum value of the cost function is a value of the cost function which can achieve the best classification performance by using the Newton algorithm.

Accordingly, the face detection training system may calculate the first weak classifier h₁ and the first weight α₁ with respect to a first stage.

In operation S940, the face detection training system updates the sample weight. Specifically, in operation S940, the face detection training system updates a training sample weight by using equation 9 below.

wₜ₊₁(i)=wₜ(i)·exp(−αₜyᵢhₜ(xᵢ))·exp(λαₜyᵢ)

In operation S950, the face detection training system determines whether a strong classifier satisfies a set performance. In this instance, the strong classifier includes a value which is acquired by multiplying the calculated first weak classifier h₁ and the first weight α₁.

Specifically, the face detection training system multiplies the first weak classifier h₁ and the first weight α₁, composes the strong classifier Hₙ(x), and determines whether a classification performance of the strong classifier Hₙ(x) satisfies the set performance.

As a result of the determination, when the classification performance satisfies the set performance, i.e., the “Y” branch of operation S950, the face detection training system stops training in operation S960. In this instance, the strong classifier Hₙ₋₁(x) becomes βₙ₋₁*Hₙ₋₁+h₁*α₁.

As a result of the determination, when the classification performance does not satisfy the set performance, i.e., the “N” branch of operation S950, the face detection training system increases a number of the weak classifier t, and calculates a subsequent weak classifier h₂ and the weight α₂. Then, the face detection training system estimates the training samples by using an i+1^{th} weight and the strong classifier Hₙ(x) including the i+1^{th} weight again. In this instance, the i+1^{th} weight is acquired by multiplying the calculated weak classifier h₂ and the weight α₂. Specifically, the face detection training system performs the operations S920, S930, S940, and S950 again. When the strong classifier Hₙ(x) satisfies the set performance, the strong classifier Hₙ(x) is calculated as βₙ₋₁*Hₙ₋₁+(h₁*α₁+h₂*α₂). More specifically, when the strong classifier Hₙ(x) does not satisfy the set performance, the face detection training system increases the number of weak classifier t, and loops.

It can be understood that each of blocks of the flowchart and combination of the flowchart of FIG. 9, as well as the above-disclosed contents, can be executed by using computer program instructions. Since the computer program instructions can be included in a processor of a general computer, a special-purpose computer, or a programmable data processing device, the instructions executed by the processors of the computer or another programmable data processing device may create a unit that executes functions described in the block of the flowchart.

These computer program instructions can be stored in a computer usable memory or computer readable memory that can aim at a computer or another programmable data processing device so as to implement the computer program instruction in a specific manner. The instructions stored in the computer usable memory or the computer readable memory can produce manufacture items including the instruction units that execute the functions described in the blocks in the block of the flowchart. Since the computer program instructions can be included in a computer or another programmable data processing device, the instructions that create a process in which a series of operation stages are performed on the computer or another programmable data processing device and executed by a computer and causes the computer or another programmable data processing device to be performed can supply procedures so as to execute the functions described in the blocks of the flowchart.

Further, each block can represent a module, a segment, or a part of codes that includes one and more executable instructions for executing specific logic functions. In addition, in some modified embodiments, it should be understood that the function described in the blocks can be executed in disorder. For example, adjacent two blocks can be substantially performed at the same time or can be performed in reverse order in accordance with a function corresponding to the block.

Although exemplary embodiments have been shown and described, the present invention is not limited thereto. Instead, it will be appreciated by those skilled in the art that changes may be made to these exemplary, non-limiting embodiments without departing from the principles and spirit of the invention, the scope of which is defined by the claims and their equivalents.

According to the present invention, a fast and accurate face detection method and system may provide a weak classifier by using a modified double sigmoid function, and thereby may estimate a Haar feature with a high accuracy and use fewer weak classifiers for each stage, but need not do so in order to be within the scope of the invention.

Also, according to the present invention, a fast and accurate face detection training method and system may provide a combination of a cascaded and a weighted chain, and thereby may use a confidence of a previous stage, but need not do so in order to be within the scope of the invention.

Also, according to the present invention, a fast and accurate face detection training method and system may provide a method of training weight of a strong classifier, and thereby may obtain an optimal weight and a parameter in each weak classifier, but need not do so in order to be within the scope of the invention.

Also, according to the present invention, a fast and accurate face detection system may be embodied.

Compared with a related art algorithm, substantially fewer weak classifiers may be required for face candidate verification at each stage in the algorithm of the exemplary embodiment.

TABLE 1

| | Stage No. | | | | |
|---|---|---|---|---|---|
| | 1 | 2 | 3 | 4 | 1~20 |
| Conventional algorithm | 5 | 6 | 7 | 13 | 2018 |
| Exemplary embodiment | 3 | 4 | 7 | 8 | 928 |

In the table 1, a number of required weak classifiers is 928 in the algorithm according to the exemplary embodiment, whereas the number of required weak classifiers is 2,018 in the related art algorithm.

Also, according to the present invention, computation complexity may be reduced so that the present invention is 1.4 times faster than a related art face detection method, and 3.1 times faster than an Intel OpenCV model, but need not do so in order to be within the scope of the invention.

Also, according to the present invention, a detail detection rate may be substantially improved, but need not do so in order to be within the scope of the invention.

TABLE 2

| | | Conventional | Exemplary |
|---|---|---|---|
| Test DB | Image number | algorithm | embodiment |
| FRGC Exp4 DB | 8014 | 97.04% | 99.89% |
| All Test DB | 20558 | 92.94% | 95.56% |

In the table 2, it is shown that the detail detection rate according to the exemplary embodiment in the ‘FRGC Exp4 DB’ and ‘All Test DB’ may be improved, but need not do so in order to be within the scope of the invention.

Also, slight posing or some occlusion may not affect the face detection system, but need not do so in order to be within the scope of the invention.

Additionally, computation time may be reduced, but need not do so in order to be within the scope of the invention. For example, the computation time with respect to an image hose size is 400*390, is about 101.2 ms, the computation time with respect to image whose size is 600*450, is about 201 ms, and the computation time with respect to image whose size is 320*240, is about 32 ms.

What is claimed is:

1. A face detection method comprising:
calculating a weak classifier associated with a stage, from a modified double sigmoid function; and
estimating a Haar feature using the calculated weak classifier.

2. The method of claim 1, wherein the stage comprises a single strong classifier H(x), and wherein a strong classifier Hₙ(x) of an n^{th} stage is given by,
Hₙ(x)=βₙ₋₁Hₙ₋₁(x)+Σαᵢhᵢ(x)
which is acquired by adding a value acquired by multiplying a strong classifier Hₙ₋₁(x) of an n+1^{th} stage and a weight βₙ₋₁, and a weighted sum of up to an i^{th} weak classifier of the n^{th} stage.

3. The method of claim 2, wherein the βₙ₋₁*Hₙ₋₁(x) is a first weak classifier of the N^{th} stage.

4. The method of claim 2, further comprising:
comparing a calculated value of the strong classifier Hₙ(x), based on an estimation of the Haar feature, with a reference value; and
determining a sub-window of an input image associated with the stage as one of a face and a non-face, according to a result of the comparing.

5. The method of claim 1, wherein the modified double sigmoid function is given by,
$$f ( g ) = [ \begin{matrix}b \frac{1 - exp ( - 2 \frac{g - t}{{r}_{1}} )}{1 + exp ( - 2 \frac{g - t}{{r}_{1}} )} & \text{if} g < t \\ a \frac{1 - exp ( - 2 \frac{g - t}{{r}_{2}} )}{1 + exp ( - 2 \frac{g - t}{{r}_{2}} )} & \text{Otherwise}\end{matrix} ,$$
and
wherein t is a threshold of two sigmoids, r₁ is a variation of a first sigmoid, r₂ is a variation of a second sigmoid, b is a weight of the first sigmoid, and a is a weight of the second sigmoid.

6. The method of claim 5, wherein the t is given by,
$$t = \text{arg} min ( {\sum }_{{X}_{i} ∈ {S}_{N} \& {g}_{i} > t} {W}_{i} {g}_{i} + {\sum }_{{X}_{i} ∈ {S}_{P} \& {g}_{i} < t} {W}_{i} {g}_{i} ) ,$$
and
wherein gᵢ is a feature value of an i^{th} sample xᵢ with respect to a feature g, and wᵢ is a histogram of the feature value gᵢ.

7. The method of claim 5, wherein r₁ and r₂ are given by,
$$\frac{{\sum }_{{X}_{i} ∈ {S}_{N} \& {g}_{i} < t - {r}_{1}} {W}_{i} {g}_{i}}{\vert {S}_{N} \vert} = \frac{{\sum }_{{X}_{i} ∈ {S}_{P} \& {g}_{i} > t + {r}_{2}} {W}_{i} {g}_{i}}{\vert {S}_{P} \vert} = CONST$$

8. The method of claim 5, wherein a and b are respectively given by,
$$a = \frac{{\sum }_{{X}_{i} ∈ {S}_{P} \& {g}_{i} > t} {W}_{i} {g}_{i}}{{\sum }_{{X}_{i} ∈ {S}_{N} \& {g}_{i} > t} {W}_{i} {g}_{i} + {\sum }_{{X}_{i} ∈ {S}_{P} \& {g}_{i} > t} {W}_{i} {g}_{i}}$$
$$b = \frac{{\sum }_{{X}_{i} ∈ {S}_{N} \& {g}_{i} < t} {W}_{i} {g}_{i}}{{\sum }_{{X}_{i} ∈ {S}_{N} \& {g}_{i} < t} {W}_{i} {g}_{i} + {\sum }_{{X}_{i} ∈ {S}_{P} \& {g}_{i} < t} {W}_{i} {g}_{i}} .$$

9. The method of claim 5, wherein the estimating estimates a sample associated with the weak classifier as a positive sample if a calculated value of the modified double sigmoid function f(g) is greater than a reference value, and the estimating estimates the sample associated with the weak classifier as a negative sample if the calculated value of the modified double sigmoid function f(g) is less than the reference value.

10. A face detection training method comprising:
calculating a modified double sigmoid function-based t^{th} weak classifier considering a training sample weight;
calculating a weight of the calculated t^{th} weak classifier;
updating the training sample weight; and
estimating whether a strong classifier, which is a weighted sum of up to a t^{th} weak classifier, satisfies a standard.

11. The method of claim 10, wherein the estimating comprises:
performing the calculating of the t^{th} weak classifier, the calculating of the weight, and the updating with respect to a t+1^{th} weak classifier if the strong classifier Hₙ(x) does not satisfy the standard; and
estimating whether a strong classifier, which is a weighted sum of up to a t+1^{th} weak classifier, satisfies the standard.

12. The method of claim 10, wherein the estimating comprises terminating the training if the strong classifier Hₙ(x) satisfies the standard.

13. A computer-readable recording medium configured to store instructions thereon for implementing a face detection method comprising:
calculating a weak classifier associated with a stage, from a modified double sigmoid function; and
estimating a Haar feature by using the calculated weak classifier.

14. The computer readable medium of claim 13, wherein the stage comprises a single strong classifier H(x), and wherein a strong classifier Hₙ(x) of an n^{th} stage is given by,
Hₙ(x)=βₙ₋₁Hₙ₋₁(x)+Σαᵢhᵢ(x)
which is acquired by adding a value acquired by multiplying a strong classifier Hₙ₋₁(x) of an n-1^{th} stage and a weight β_{n-1,} and a weighted sum of up to an i^{th} weak classifier of the n^{th} stage, and further comprising:
comparing a calculated value of the strong classifier Hₙ(x), based on an estimation of the Haar feature, with a reference value; and
determining a sub-window of an input image associated with the stage as one of a face and a non-face, according to a result of the comparing.

15. A computer-readable recording medium configured to store instructions for implementing a face detection training method comprising:
calculating a modified double sigmoid function-based t^{th} weak classifier considering a training sample weight;
calculating a weight of the calculated t^{th} weak classifier;
updating the training sample weight; and
estimating whether a strong classifier, which is a weighted sum of up to a t^{th} weak classifier, satisfies a standard.

16. The computer readable medium of claim 15, wherein the estimating comprises:
performing the calculating of the t^{th} weak classifier, the calculating of the weight, and the updating with respect to a t+1^{th} weak classifier if the strong classifier Hₙ(x) does not satisfy the standard; and
estimating whether a strong classifier, which is a weighted sum of up to a t+1^{th} weak classifier, satisfies the standard.

17. A face detection system comprising:
a weak classifier calculation unit that calculates a weak classifier associated with a stage, from a modified double sigmoid function;
a Haar feature estimation unit that estimates a Haar feature using the calculated weak classifier;
a comparison unit that compares a calculated value of a strong classifier Hₙ(x), based on an estimation of the Haar feature, with a reference value; and
a determination unit that determines a sub-window of an input image associated with the stage as a face or a non-face, based on a result of the comparison by the comparison unit.

18. The system of claim 17, wherein the stage comprises a single strong classifier H(x), and wherein a strong classifier Hₙ(x) of an n^{th} stage is given by,
Hₙ(x)=βₙ₋₁Hₙ₋₁(x)+Σαᵢhᵢ(x)
which is acquired by adding a value acquired by multiplying a strong classifier Hₙ₋₁(x) of an n-1^{th} stage and a weight βₙ₋₁, and a weighted sum of up to an i^{th} weak classifier of the n^{th} stage.

19. The system of claim 17, wherein the modified double sigmoid function is given by,
$$f ( g ) = [ \begin{matrix}b \frac{1 - exp ( - 2 \frac{g - t}{{r}_{1}} )}{1 + exp ( - 2 \frac{g - t}{{r}_{1}} )} & if g < t \\ a \frac{1 - exp ( - 2 \frac{g - t}{{r}_{2}} )}{1 + exp ( - 2 \frac{g - t}{{r}_{2}} )} & Otherwise\end{matrix} ,$$
and
wherein t is a threshold of two sigmoids, r¹ is a variation of a first sigmoid, r₂ is a variation of a second sigmoid, b is a weight of the first sigmoid, and a is a weight of the second sigmoid.
